(19) United States
(12) Patent Application Publication
(10) Pub. No.: US 2020/0372377 A1
(43) Pub. Date: Nov. 26, 2020

(54) PREDICTION DEVICE, PREDICTION SYSTEM, PREDICTION METHOD, AND NON-TRANSITORY COMPUTER-READABLE MEDIUM

(71) Applicant: MITSUBISHI HEAVY INDUSTRIES, LTD., Tokyo (JP)

(72) Inventors: Takaharu HIROE, Tokyo (JP); Kazunari IDE, Tokyo (JP); Ryo SASE, Tokyo (JP)

(21) Appl. No.: 16/878,924

(22) Filed: May 20, 2020

(30) Foreign Application Priority Data
May 22, 2019 (JP) 2019-096151
Apr. 27, 2020 (JP) 2020-078508

(51) Int. Cl. G06N 5/04; G06N 20/00

(52) U.S. Cl. CPC G06N 5/04; G06N 20/00

(57) ABSTRACT

A prediction device that predicts an output of a prediction target in the future includes a processor and a recording device that is connected to the processor and stores an input measurement value that is a measured value of an input of the prediction target and an output measurement value that is a measured value of the output. The processor executes: an identification process of identifying a first coefficient for the input using a moving average filter from a plurality of input measurement values and a plurality of output measurement values stored in the past; and a prediction process of predicting the output of the prediction target in the future on the basis of a prediction model formed from the input measurement values, the output measurement values, and the first coefficient.

### TECHNICAL FIELD

The present disclosure relates to a prediction device, a prediction system, a prediction method, and a non-transitory computer-readable medium. Priority is claimed on Japanese Patent Application No. 2019-096151, filed May 22, 2019, and Japanese Patent Application No. 2020-078508, filed Apr. 27, 2020, the content of which is incorporated herein by reference.

### BACKGROUND ART

In various fields such as the energy business field including the power supply business, the gas supply business, and the like, the communication business field, and the transportation business field of taxis and delivery businesses, future demand quantities are predicted for operating facilities and appropriately allocating resources in accordance with consumer demand. In the prediction of a future demand quantity, a numerical model (prediction model) of a prediction target is used.

However, characteristics of a prediction target are not fixed but vary over time. Accordingly, there may be a deviation between a predicted value calculated using a numerical model set at a certain time point and an actually observed value. For this reason, in order to improve prediction accuracy, it is conceivable that the prediction model be updated in accordance with elapse of a time (for example, see Patent Literature 1).

In addition, the update of a prediction model is performed on the basis of observed values that have been actually acquired in the past. Practically, it is preferable that there is less data (for example, observed values of an input and an output) used for updating the prediction model. The reason for this is that, in a case in which a prediction model can be updated using less data (data representing an input and an output for a short period), even when the characteristics of the prediction target vary in a short time, such a variation can be obtained using the prediction model. For example, in a case in which the characteristics of the prediction target vary over ten minutes, when the model can be updated on the basis of observed values corresponding to one minute in the past, the prediction model can be updated in accordance with the variation. On the other hand, in a case in which observed values corresponding to 60 minutes in the past are required for updating the model, the prediction model is updated after several tens of minutes after the prediction target varies, and accordingly, there is a possibility of a prediction being different from an actual value.

In recent years, as a technology enabling a prediction using less data, a kernel-based system identification method has been conceived (for example, see Non-Patent Literatures 1 and 2). In the kernel-based system identification method, a prediction model is updated by identifying an impulse response of a prediction target through Bayes estimation. Here, an output of the prediction target is represented in the form of a moving average filter (MA filter). More specifically, when an input of the prediction target is denoted by ui (here, i=t, t−1, t−2, . . . ), and an output is denoted by yi (here, i=t, t−1, t−2, . . . ), the output y is represented as a sum of a weighted moving average of the input u and observed noise. Weighting factors {a₁, a₂, . . . , aₙ} of the weighted moving averages correspond to a finite impulse response of the prediction target. It is assumed that observed noise is represented in a normal distribution of which an average is zero, and a standard deviation is σ_{w}. In addition, the standard deviation σ is given in advance. In the prediction model using the moving average filter, the values of the weighting factors {a₁, a₂, . . . , aₙ} are set on the basis of the observed values y and u of the actual input and the actual output. In the kernel-based system identification method, the values of {a₁, a₂, . . . , aₙ} are set by introducing a prior distribution of which an average is zero and a covariance matrix is K(n×n) to the weighting factors {a₁, a₂, . . . , aₙ} and introducing a prior distribution of which an average is zero and a covariance matrix is σ_{w}²I(n×n) to the observed noise. This K is called a kernel matrix and has prior information of a prediction target built thereinto.

### CITATION LIST

### Patent Literature

[Patent Literature 1] Japanese Unexamined Patent Application, First Publication No. 2018-163515

### Non-Patent Literature

[Non-Patent Literature 1] Y Fujimoto and T. Sugie: A Study on Input Design for Kernel-Based System Identification, Proceedings of the 59th Japan Joint Automatic Control Conference, Kitakyushu, 2016.11. 10-12, pp. 448-449 (2016.11. 10)
[Non-Patent Literature 2] G. Pillonetto, A. Chiuso and G. De Nicolao, “Prediction error identification of linear systems: A nonparametric Gaussian regression approach,” Automatica, 47(2), 291-305, 2011.

### SUMMARY OF INVENTION

However, generally, a prediction target is influenced by a plurality of inputs. In a prediction model using the moving average filter as described above, a response (output y) of the prediction target is predicted for one specific input (input u). In other words, the response of the prediction target is considered to be influenced only by one specific input. For this reason, a response cannot be represent by a prediction model when an unknown input (external disturbance) that cannot be measured is added. For this reason, in a conventional technology, when there is an influence according to an external disturbance that cannot be measured, there is a possibility of prediction accuracy being lowered.

The present disclosure is in view of such problems and provides a prediction device, a prediction system, a prediction method, and a non-transitory computer readable-medium capable of inhibiting a decrease in the prediction accuracy of an output of a prediction target by using statistics such as a standard deviation indicating prior information of an external disturbance even in a case in which there is an influence according to external disturbances that cannot be measured.

In order to solve the problems described above, the present disclosure employs the following means.

According to an aspect of the present disclosure, there is provided a prediction device that is configured to predict an output of a prediction target in the future including: a processor; and a recording device that is connected to the processor and is configured to store an input measurement value that is a measured value of an input of the prediction target and an output measurement value that is a measured value of the output. The processor is configured to execute: an identification process of identifying a first coefficient for the input using a moving average filter from a plurality of input measurement values and a plurality of output measurement values stored in the past; and a prediction process of predicting the output of the prediction target in the future on the basis of a prediction model formed from the input measurement values, the output measurement values, and the first coefficient. Regarding the identification process, in an evaluation of a prior distribution of a predicted value of output y, a covariance matrix of input disturbance weighted by a kernel matrix with respect to the first coefficient is used.

According to at least one of the aspects described above and below, even in a case in which there is an influence according to external disturbances that cannot be measured, a decrease in the prediction accuracy of an output of a prediction target can be inhibited by using prior information of a standard deviation of an external disturbance.

### BRIEF DESCRIPTION OF DRAWINGS

FIG. 1A is a diagram illustrating the functional configuration of a prediction system according to a first embodiment of the present disclosure.

FIG. 1B is a diagram illustrating the functional configuration of a prediction system according to a second embodiment of the present disclosure.

FIG. 2 is a diagram illustrating an application example of a prediction system according to the second embodiment of the present disclosure.

FIG. 3 is a diagram illustrating the functional configuration of a prediction system according to a third embodiment of the present disclosure.

FIG. 4 is a diagram illustrating the functional configuration of a prediction system according to a fourth embodiment of the present disclosure.

FIG. 5 is a diagram illustrating the functional configuration of a prediction system according to a fifth embodiment of the present disclosure.

FIG. 6 is a diagram illustrating one example of the hardware configurations of a prediction device and a control device according to at least one embodiment of the present disclosure.

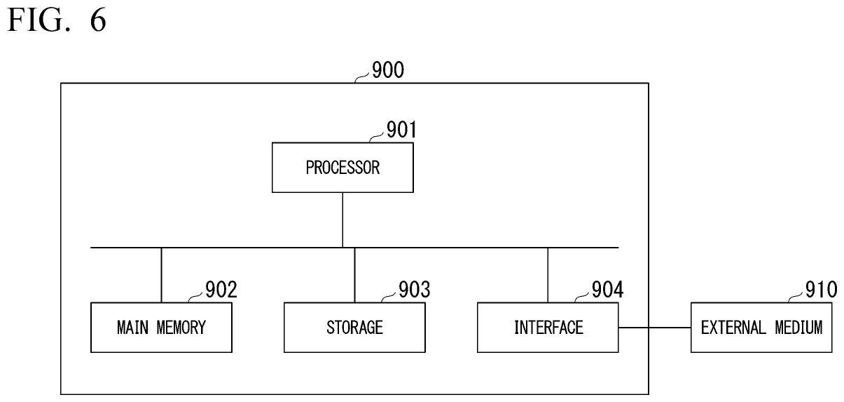

### DESCRIPTION OF EMBODIMENTS

### First Embodiment

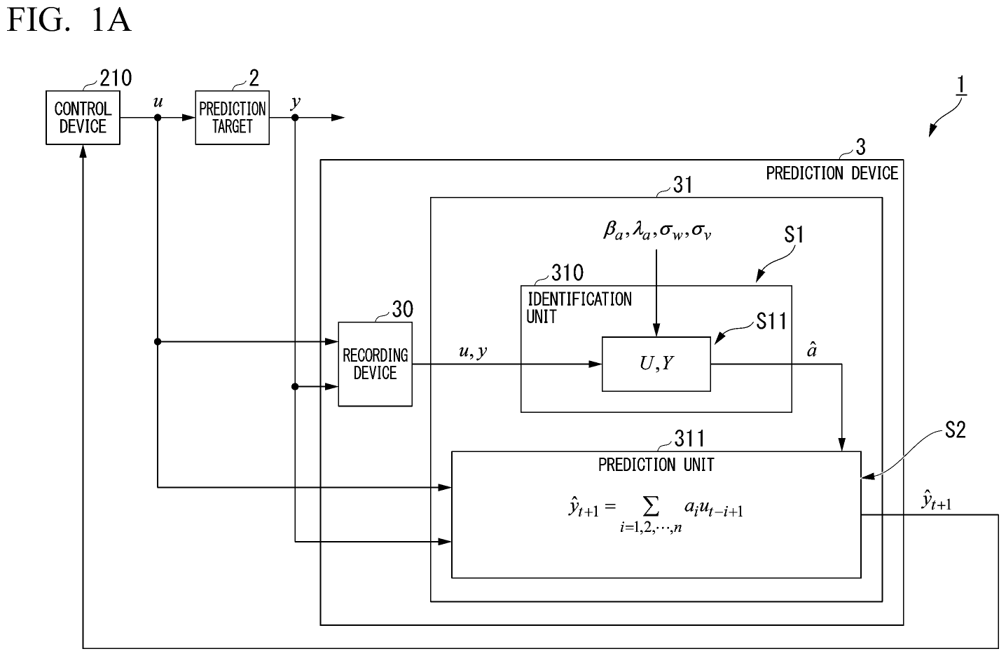

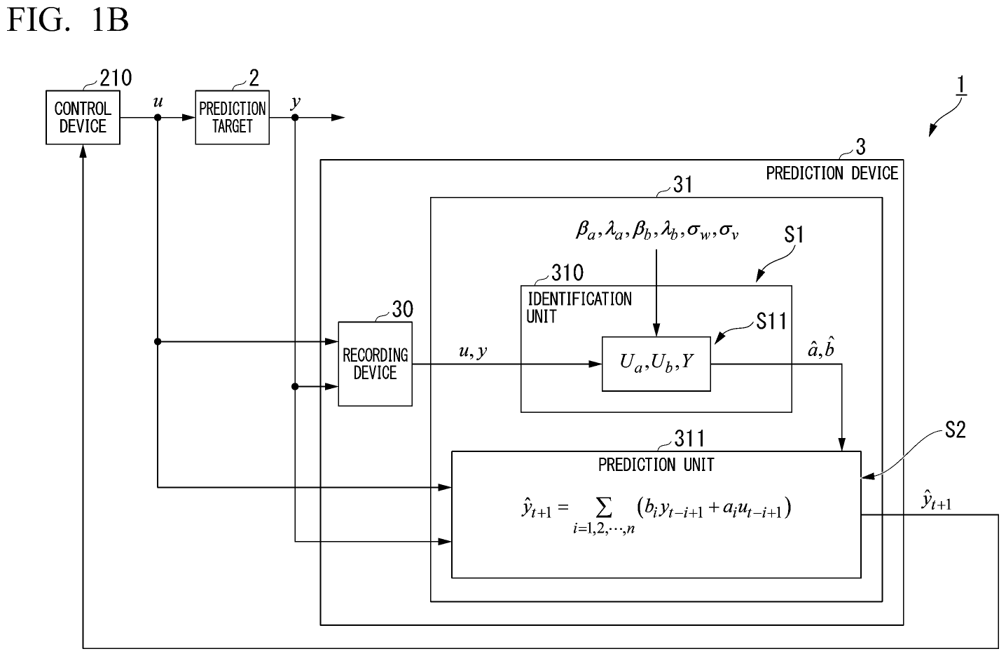

Hereinafter, a prediction device according to a first embodiment of the present disclosure and a prediction system including the prediction device will be described with reference to FIG. 1A.

### (Functional Configuration)

FIG. 1A is a diagram illustrating the functional configuration of the prediction system according to the first embodiment of the present disclosure.

As illustrated in FIG. 1A, the prediction system 1 includes a prediction device 3 that predicts an output of a prediction target 2 in the future.

The prediction device 3 according to the present embodiment predicts an output in the future using a technology of a kernel-based system identification method. The prediction device 3 is configured using a server or a computer such as a personal computer and includes a recording device 30 and a processor 31.

The recording device 30 is connected to the processor 31 and stores a measured value of an input (hereinafter, referred to as an “input measurement value u”) and a measured value of an output (hereinafter, referred to as an “output measurement value y”) that are received from the prediction target 2 for every predetermined period.

The processor 31 is responsible for the entire operation of the prediction device 3. The processor 31 operates in accordance with a predetermined program, thereby exhibiting functions of an identification unit 310 and a prediction unit 311.

The identification unit 310 executes an identification process S1 of identifying a first coefficient a for an input of the prediction target 2 from a plurality of input measurement values u and a plurality of output measurement values y stored in the past using a moving average filter (a MA filter).

The prediction unit 311 executes a prediction process S2 of predicting an output of the prediction target 2 in the future on the basis of a prediction model formed from an input measurement value u, an output measurement value y, and a first coefficient a.

### (Regarding Kernel-Based System Identification Method)

Here, an identification process of a conventional kernel-based system identification method will be described. In the conventional kernel-based system identification method, when an input measurement value of a prediction target for each time is denoted by uᵢ (here, i=t, t−1, t−2, . . . ), and an output measurement value is denoted by yᵢ (here, i=t, t−1, t−2, . . . ), an output yₜ₊₁ of the prediction target at one step ahead (a time t+1) is, as represented in the following Equation (1), represented in the form of a moving average filter (an MA filter). In addition, a denotation “\hat{ }y” in description here corresponds to a denotation in which a hat symbol “\hat{ }” is attached to “y” in the following drawings and equations. Similarly, denotations “\hat{ }K” and “\hat{ }a” in description here correspond to denotations in which a hat symbol “\hat{ }” is attached to “K” and “a” in the following drawings and equations.

$$\begin{matrix}[ Math . 1 ] & \\ {y}_{t + 1} = {\sum }_{i = 1 , 2 , … , n} {a}_{i} {u}_{t - i + 1} + {w}_{t + 1} , {\hat{y}}_{t + 1} = {\sum }_{i = 1 , 2 , … , n} {a}_{i} {u}_{t - i + 1} & ( 1 )\end{matrix}$$

In Equation (1) shown above, an output y of a prediction target is represented as a sum of a weighted moving average of input measurement values u and observed noise w. The weighting factors of the weighted moving average are {a₁, a₂, . . . , aₙ}. These weighting factors correspond to an impulse response of a prediction target. It is assumed that the observed noise w is a normalized distribution of which an average is “0”, and a standard deviation is “σ_{w}”, in other words, the observed noise is represented in w˜N(0, σ_{w}²). “\hat{ }yₜ₊₁” is a predicted value of “yₜ₊₁”. An equation for acquiring this “\hat{ }yₜ₊₁” represents a prediction model.

A kernel-based system identification method is characterized in that the weighting factors {a₁, a₂, . . . , aₙ} of input as random variables following a multivariate normal distribution by using Bayes estimation. For the sake of simplifying, the weighting factors {a₁, a₂, . . . , aₙ} of input in the Equation (1) are represented by a column vector a. Specifically, in the multivariate normal distribution in which the column vector a follows, an average is “0(n×1)” and a covariance matrix is “K(n×n)”. That is, the column vector is represented as a˜N(0, K). In the kernel-based system identification method, the covariance matrix K is called a kernel matrix and represents prior information related to a prediction target. For example, according to a first-degree stable spline kernel (a Tuned and Correlated kernel), a kernel matrix can be determined from prior information of a time constant indicating that an impulse response of the prediction target exponentially converges with respect to time. Specifically, according to the first-degree stable spline kernel, an element in an i-th row and a j-th column of the kernel matrix K is given in the following Equation (2). Here, λ is a parameter representing an amplitude of an impulse response of the output y with respect to the input u, and β is a parameter representing a speed of a convergence of the impulse response.

Approximate values of these parameters are easily obtained from operation experience and operation records of the prediction target.

[Math. 2]

[K]_{i,j}=λβ^{max(i,j)}, λ>0, 0<β<1 (2)

In addition, when a vector denotation is introduced, an input measurement value u and an output measurement value y are represented in the following Equation (3). Here, N is the number of observation points (the number of steps) used for calculation, and n is a degree of impulse responses (the number of elements of the weighting factor a).

$$\begin{matrix}[ Math . 3 ] & \\ U = [ \begin{matrix}{u}_{0} & 0 & & … & 0 \\ {u}_{1} & {u}_{0} & 0 & & 0 \\ ⋮ & ⋮ & ⋱ & & ⋮ \\ {u}_{N - 2} & {u}_{N - 3} & … & & {u}_{N - n - 1} \\ {u}_{N - 1} & {u}_{N - 2} & … & … & {u}_{N - n}\end{matrix} ] , Y = [ \begin{matrix}{y}_{1} \\ {y}_{2} \\ ⋮ \\ {y}_{N - 1} \\ {y}_{N}\end{matrix} ] & ( 3 )\end{matrix}$$

When U is known, and the kernel matrix K and a standard deviation σ_{w} of observed noise are known as prior information, in the sense of Bayes estimation, a prior distribution of the weighting factor a and the output measurement value Y are represented as a multivariate normal distribution like the following Equation (4) In the Equation (4), a first term inside brackets of a symbol N is an expectation value and a second term inside the brackets of the symbol N is a covariance matrix.

$$\begin{matrix}[ Math . 4 ] & \\ [ \begin{matrix}a \\ Y\end{matrix} ] ∼ 𝒩 ( [ \begin{matrix}0 \\ 0\end{matrix} ] , [ \begin{matrix}K & K {U}^{T} \\ U K & U K {U}^{T} + {σ}_{w}^{2} I\end{matrix} ] ) & ( 4 )\end{matrix}$$

At this time, when the output measurement value y_{N} is obtained in addition to the prior information described above, in the sense of Bayes estimation, an optimum estimate of the weighting factor a is represented as the following Equation (5), as an average value of a posterior distribution.

$$\begin{matrix}[ Math . 5 ] & \\ \begin{matrix}\hat{a} = {{KU}^{T} ( {UKU}^{T} + {σ}_{w}^{2} I )}^{- 1} Y \\ = {K ( {U}^{T} UK + {σ}_{w}^{2} {I}_{n} )}^{- 1} {U}^{T} Y\end{matrix} & ( 5 )\end{matrix}$$

In the Equation (4), a in the left side of the equation (4) represents to the weighting factor a {a₁, a₂, aₙ} in the Equation (1) in the form of a column vector. In the multivariate normal distribution in the Equation (4), an element (2, 2) of the covariance matrix represents a covariance matrix Var(Y) of a prediction value of the output measurement value Y. This is represented as: Var(Y)=Var(Ua+W)=E(Uaa^{T}U^{T})+E(UaW^{T})+E(Wa^{T}U^{T})+E(WW^{T}), by using a column vector W(N×1) of a time series {w₁, w₂, . . . , w_{N}} of the observed noise. According to the definition of the kernel matrix, it is represented as: E(aa^{T})=K. Since the observed noise and the input are uncorrelated, it is represented as: E(UW^{T})=0. Further, according to the definition of the observed noise, it is represented as: E(WW^{T})=σ_{w}²I. Thus, it is represented as: Var(Y)=UKU^{T}+0+0+σ_{w}²I.

In the conventional kernel-based system identification method, there is an advantage of acquiring a prediction model using a small number N of pieces of data. In a general technique, there are cases in which a number of pieces of data of about 2,000 is required when the number of constants of the prediction model is 5 to 10. In contrast to this, in a kernel-based system identification method, identification can be performed with the number N of pieces of data being about 200.

However, the conventional kernel-based system identification method merely considers the observed noise. Thus, in the conventional method, when external disturbance is superimposed to the input, there is a possibility of prediction accuracy being degraded. The external disturbance superimposed to the input includes, for example, error in an operation amount of a valve and the like in addition to noise for transmitting an instruction signal of the input. The external disturbance is hereinafter referred to as an input disturbance. In order to handle the input disturbance, in the prediction device 3 according to the present embodiment, as will be described below, an identification process S1 and a prediction process S2 different from those of a conventional case are performed.

### (Process of Prediction Device by a Moving Average Filter)

The prediction device 3 according to the present embodiment uses a moving average filter (a MA filter) as with the conventional method. However, in the moving average filter of the present embodiment, an output “yₜ₊₁” of the prediction target 2 at one step ahead (a time t+1) is represented as in the following Equation (6) with consideration of the input disturbance v and the identification process S1 is performed. Here, the input disturbance v follows a Gauss distribution of which an average is zero, and a standard deviation is σᵥ. This is denoted as v˜N(0, σᵥ²). The observed noise w is same as the conventional method. “\hat{ }yₜ₊₁” is a prediction value of “yₜ₊₁”. An equation to obtain “\hat{ }yₜ₊₁” represents a prediction model of the present embodiment.

$$\begin{matrix}[ Math . 6 A ] & \\ {y}_{t + 1} = {\sum }_{i = 1 , 2 , … , n} {a}_{i} ( {u}_{t - i + 1} + {v}_{t - i + 1} ) + {w}_{t + 1} , \\ {\hat{y}}_{t + 1} = {\sum }_{i = 1 , 2 , … , n} {a}_{i} {u}_{t - i + 1} & ( 6 A )\end{matrix}$$

In the present embodiment, an impact of the input disturbance on the prediction value is considered, which is different from the conventional method. Regarding a model in the form of the moving average filter of the Equation (6A), when the kernel matrix K, the standard deviation σᵥ of the input disturbance, the standard deviation σ_{w} of the observed noise, and the input measurement value u are known as prior information, in the sense of Bayes estimation, the weighting factor a (a first coefficient) a and the prior distribution of the prediction value of the output measurement value Y are represented by the multivariate normal distribution, as shown in the following Equation (6B). In the Equation (6B), a first term inside brackets of a symbol N is an expectation value and a second term inside the brackets of the symbol N is a covariance matrix.

In the multivariate normal distribution of the Equation (6B), an element (2, 2) of the covariance matrix represents the covariance matrix Var(Y) of the prediction value of the output measurement value Y. As an evaluation means of Var(Y) is a one of characterizing portions of the present disclosure, a process to obtain this value will be explained below. According to the Equation (6A), it is represented as: Var(Y)=UKU^{T}+DK+σ_{w}²I. This is further represented as: Var(Y)=Var((U+V)a+W)=E(Uaa^{T} U^{T})+E(Vaa^{T}V^{T})+E((U+V)aW^{T})+E(Wa^{T}(U^{T}+V^{T}))+E(WW^{T}), when the time series of the observed noise {w₁, w₂, . . . , w_{N}} is represented by a column vector W(N×1) and the time series of the input disturbance {v₁, v₂, . . . , v_{N}} is represented as a column vector V(N×1). It is represented as: E(aa^{T})=K from the definition of the kernel matrix. It is represented as: E((U+V)W^{T})=0, since the input is uncorrelated to the observed noise and the input disturbance. It is represented as: E(WW^{T})=σ_{w}²I from the definition of the observed noise. Thus, it is represented as: Var(Y)=UKU^{T}+E(VKV^{T})+0+0+σ_{w}²I. E(VKV^{T}) is a covariance matrix of the input disturbance weighted by the kernel matrix with respect to the first coefficient, and denoted by D_{K} in the Equation (6B). [0038]

$$\begin{matrix}[ Math . 6 B ] & \\ [ \begin{matrix}a \\ Y\end{matrix} ] \text{∼} 𝒩 ( [ \begin{matrix}0 \\ 0\end{matrix} ] , [ \begin{matrix}K & K {U}^{T} \\ U K & U K {U}^{T} + {D}_{K} + {σ}_{w}^{2} I\end{matrix} ] ) & ( 6 B )\end{matrix}$$

The matrix D_{K} which configures the covariance matrix is the covariance matrix of the input disturbance weighted by the kernel matrix K with respect to the first coefficient a, which is one of characterizing portion of the present disclosure. The structure of the matrix D_{K} is represented as the Equation (6C), and elements therein are calculated by the Equation (6D). In the Equation (6D), a symbol Tr denotes a trace of the matrix, i.e., a sum of on-diagonal elements of the matrix. Further, eₚ and e_{q} are row vectors respectively representing p-th and q-th basis of a N-dimensional linear space. It is represented as “eₚe_{q}^{T}=0” when “p=q” and it is represented as “eₚe_{q}^{T}=1” when “p≠q”.

$$\begin{matrix}[ Math . 6 C ] & \\ [ \begin{matrix}{d}_{1} & {d}_{2} & … & {d}_{n} & 0 & … & 0 \\ {d}_{2} & {d}_{1} & {d}_{2} & … & {d}_{n} & ⋱ & ⋮ \\ ⋮ & {d}_{2} & {d}_{1} & ⋱ & ⋱ & ⋱ & 0 \\ {d}_{n} & ⋱ & ⋱ & ⋱ & ⋱ & ⋱ & {d}_{n} \\ 0 & {d}_{n} & ⋱ & ⋱ & ⋱ & ⋱ & ⋮ \\ ⋮ & ⋱ & ⋱ & ⋱ & ⋱ & ⋱ & {d}_{2} \\ 0 & … & 0 & {d}_{n} & … & {d}_{2} & {d}_{1}\end{matrix} ] & ( 6 C ) \\ [ Math . 6 D ] & \\ \begin{matrix}{[ {D}_{K} ]}_{ij} = {σ}_{v}^{2} {d}_{1 + \vert i - j \vert} \\ = {\sum }_{{p = i , i + 1 , … , i + n}_{q = j , j + 1 , … , i + n}} E ( {{v}_{p} [ K ]}_{i , j} {v}_{q} ) \\ = {\sum }_{{p = 1 , 2 , … , n - \vert i - j \vert}_{q = 1 + \vert i - j \vert , … n - 1. , n}} {σ}_{v} {e}_{p} {Ke}_{q}^{T} {σ}_{v} \\ = {σ}_{v}^{2} Tr ( K [ \begin{matrix}{O}_{\vert i - j \vert \times n - \vert i - j \vert} & {O}_{\vert i - j \vert \times \vert i - j \vert} \\ {I}_{n - \vert i - j \vert} & {O}_{n - \vert i - j \vert \times \vert i - j \vert}\end{matrix} ] )\end{matrix} & ( 6 D )\end{matrix}$$

At this time, when the output measurement value y is obtained in addition to the above-described prior information, in the sense of the Bayes estimation, the optimum estimate of the first coefficient a is represented as an average value of the posterior distribution, as shown in the Equation (6E). Since an optimum value of the first coefficient a obtained by the conventional method does not include the matrix D_{K} as shown in the Equation (5), the input disturbance is not considered and the first coefficient a cannot be properly estimated by the conventional method. The difference between the present embodiment and the conventional method depends on whether the covariance matrix D_{K} of the input disturbance weighted by the kernel matrix K with respect to first coefficient a is considered or not. In the technique according to the present embodiment, since an impact of the input disturbance on the prior distribution of the output Y is considered from the standard deviation σᵥ and the kernel matrix K with respect to the first coefficient a, it is able to improve the estimation accuracy of the first coefficient a is particularly when the input disturbance exists.

[Math. 6E]

â=K(U^{T}UK+U^{T}D_{K}U(U^{T}U)⁻¹+σ_{w}²Iₙ)⁻¹U^{T}Y (6E)

The value of this “a” in the above Equation (6E) is used for a constant (the first coefficient a) of the prediction model.

The identification unit 310 updates the prediction model by executing the identification process S1 described above for every predetermined time (for example, 10 minutes). In this way, the identification unit 310 can constantly provide the prediction model according to changes in the characteristics of the prediction target 2. The predetermined time is arbitrarily set in accordance with a variation period and the like of the characteristics of the prediction target 2.

In addition, the prediction unit 311 executes a prediction process S2 of predicting an output of the prediction target 2 at one step ahead (a time t+1) on the basis of constants (the first coefficient a) identified by the identification unit 310 and a prediction model formed from the input measurement value u and the output measurement value y.

A predicted value “\hat{ }yₜ₊₁” predicted by the prediction unit 311 is transmitted to the control device 210 of the prediction target 2. Then, the control device 210 performs control and adjustment on the basis of this predicted value “\hat{ }yₜ₊₁” such that the output of the prediction target 2 becomes an appropriate value.

### (Operation and Effect)

As described above, the prediction device 3 of the prediction system according to the present embodiment uses the covariance matrix of the input disturbance weighted by the kernel matrix with respect to the first coefficient a in the identification process S1. In this way, even in a case in which there is an impact on an input caused by an external disturbance which cannot be observed, the prediction device 3 can inhibit a decrease in the prediction accuracy by using prior information related to a standard deviation of the external disturbance.

### Second Embodiment

Next, a prediction device and a prediction system 1 including the prediction device according to a second embodiment of the present disclosure will be described with reference to FIG. 1B. The difference between the first embodiment and the second embodiment is that the second embodiment uses an autoregressive moving average filter while the first embodiment uses a moving average filter. Since the difference affects only the identification process S1 performed by the identification unit 310 and the prediction process S2 performed by the prediction unit 311, these processes will be described below. The other functions and configurations are same as the first embodiment.

### (Process of Prediction Device by an Autoregressive Moving Average Filter)

The identification unit 310 of the prediction device 3 according to the present embodiment performs the identification process S1 using an autoregressive moving average filter (an ARMA filter) instead of the moving average filter of the first embodiment. In the autoregressive moving average filter, an output “yₜ₊₁” of the prediction target 2 at one step ahead (a time t+1) is represented as in the following Equation (6F). In addition, observed noise w is similar to that of the conventional technique. Here, “\hat{ }yₜ₊₁” is a predicted value of “yₜ₊₁”. An equation for acquiring this “\hat{ }yₜ₊₁” represents a prediction model according to the present embodiment.

$$\begin{matrix} [ Math . 6 F ] & \\ {y}_{t + 1} = {\sum }_{i = 1 , 2 , … , n} ( {a}_{i} ( {u}_{t - i + 1} + {v}_{t - i + 1} ) + {b}_{i} ( {y}_{t - i + 1} + {w}_{t - i + 1} ) ) + {w}_{t + 1} , \\ {\hat{y}}_{t + 1} = {\sum }_{i = 1 , 2 , … , n} {a}_{i} {u}_{t - i + 1} + {b}_{i} {y}_{t - i + 1} & ( 6 F )\end{matrix}$$

In the present embodiment, output measurement values y in the past are used for a prediction, which is different from the technique using the moving average filter of the first embodiment. In accordance with this, the identification unit 310 identifies not only a coefficient for an input (hereinafter, referred to also as a “first coefficient”) but also a coefficient for the output (hereinafter, referred to also as a “second coefficient”). In order to realize this, a covariance matrix of the first coefficient a with respect to the input is denoted by the kernel matrix Kₐ, and a covariance matrix of the second coefficient b with respect to the output is denoted by the kernel matrix K_{b}, respectively.

Elements in the i-th row and the j-th column of the kernel matrixes Kₐ and K_{b} are given in the following Equations (8) and (9). It is assumed that there is prior information of values of λₐ, λ_{b}, βₐ, and thereby approximate values of λₐ, λ_{b}, βₐ, and β_{b} are known in advance. In addition, the values of λₐ and λ_{b} may be the same or may be different from each other. Similarly, the values of βₐ and β_{b} may be the same or may be different from each other. Further, although both the first coefficient a{a₁, a₂, . . . } and the second coefficient b {b₁, b₂, . . . } have a same length n in the Equation (6F), they may have a different length. For example, the first coefficient a may have a length of zero.

[Math. 8]

[Kₐ]_{i,j}=λₐβₐ^{max{i,j}}, λₐ>0, 0<βₐ<1 (8)

[Math. 9]

[K_{b}]_{i,j}=λ_{b}β_{b}^{max{i,j}}, λ_{b}>0, 0<β_{b}<1 (9)

In addition, when a vector denotation represented in the following Equation (10) is introduced, a prior distribution of a constant [a^{T}, b^{T}]^{T} of the prediction model is represented as the following Equation (12).

In a multivariate normal distribution of the Equation (11), an element (3, 3) of the covariance matrix represents the covariance matrix Var(Y) of the prediction value of the output measurement value Y. In the Equation (11), it is represented as: Var(Y)=UₐKₐUₐ^{T}+U_{b}K_{b}U_{b}^{T}+D_{Ka}+D_{Kb}+σ_{w}²I. This can be obtained as follows. When the time series of the observed noise {w₁, w₂, . . . , w_{N}} is represented by a column vector W(N×1) and the time series of the input disturbance {v₁, v₂, . . . , v_{N}} is represented as a column vector V(N×1), it is represented as: Var(Y)=Var((Uₐ+V)a+(U_{b}+W)b+W)=E(UₐKₐUₐ^{T})+E(U_{b}K_{b}U_{b}^{T})+E(VKₐV^{T})+E(WK_{b}W^{T})+E((Uₐ+V)ab^{T}(Ub+W)^{T})+E((U_{b}+W)ba^{T}(Uₐ+V)^{T})+E(WW^{T}). Thus, it is represented as: Var(Y)=UₐKₐUₐ^{T}+U_{b}K_{b}U_{b}^{T}+D_{Ka} D_{Kb}+0+0+σ_{w}²I. E(VKₐV^{T}) is a covariance matrix of the input disturbance weighted by the kernel matrix with respect to the first coefficient a and denoted by D_{Ka}. E(WK_{b}W^{T}) is a covariance matrix of the observed noise weighted by the kernel matrix with respect to the second coefficient b and denoted by D_{Kb}.

$$\begin{matrix} [ Math . 10 ] & \\ {U}_{a} = [ \begin{matrix}{u}_{0} & 0 & & … & 0 \\ {u}_{1} & {u}_{0} & 0 & & 0 \\ ⋮ & ⋮ & ⋱ & & ⋮ \\ {u}_{N - 2} & {u}_{N - 3} & … & & {u}_{N - n - 1} \\ {u}_{N - 1} & {u}_{N - 2} & … & … & {u}_{N - n}\end{matrix} ] , \\ {U}_{b} = [ \begin{matrix}{y}_{0} & 0 & & … & 0 \\ {y}_{1} & {y}_{0} & 0 & & 0 \\ ⋮ & ⋮ & ⋱ & & ⋮ \\ {y}_{N - 2} & {y}_{N - 3} & … & & {y}_{N - n - 1} \\ {y}_{N - 1} & {y}_{N - 2} & … & … & {y}_{N - n}\end{matrix} ] , Y = [ \begin{matrix}{y}_{1} \\ {y}_{2} \\ ⋮ \\ {y}_{N - 1} \\ {y}_{N}\end{matrix} ] & ( 10 ) \\ [ Math . 11 ] & \\ [ \begin{matrix}a \\ b \\ Y\end{matrix} ] \text{∼} 𝒩 ( [ \begin{matrix}0 \\ 0 \\ 0\end{matrix} ] , [ \begin{matrix}{K}_{a} & 0 & {K}_{a} {U}_{a}^{T} \\ 0 & {K}_{b} & {K}_{b} {U}_{b}^{T} \\ {U}_{a} {K}_{a} & {U}_{b} {K}_{b} & {U}_{a} {K}_{a} {U}_{a}^{T} + {U}_{b} {K}_{b} {U}_{b}^{T} + {D}_{{K}_{a}} + {σ}_{w}^{2} I\end{matrix} ] ) & ( 11 ) \\ [ Math . 12 ] & \\ [ \begin{matrix}\hat{a} \\ \hat{b}\end{matrix} ] = [ \begin{matrix}{K}_{a} & 0 \\ 0 & {K}_{b}\end{matrix} ] ( [ \begin{matrix}{U}_{a}^{T} {U}_{a} {K}_{a} & {U}_{a}^{T} {U}_{b} {K}_{b} \\ {U}_{b}^{T} {U}_{a} {K}_{a} & {U}_{b}^{T} {U}_{b} {K}_{b}\end{matrix} ] + { [ \begin{matrix}{U}_{a}^{T} \\ {U}_{b}^{T}\end{matrix} ] {( {D}_{{K}_{a}} + {D}_{{K}_{b}} ) [ {U}_{a} {U}_{b} ] [ \begin{matrix}{U}_{a}^{T} {U}_{a} & {U}_{a}^{T} {U}_{b} \\ {U}_{b}^{T} {U}_{a} & {U}_{b}^{T} {U}_{b}\end{matrix} ]}^{- 1} + {σ}_{w}^{2} {I}_{n} )}^{- 1} [ \begin{matrix}{U}_{a}^{T} \\ {U}_{b}^{T}\end{matrix} ] Y & ( 12 )\end{matrix}$$

In addition to the prior distribution, when the output measurement value y is obtain, optimum estimates of the first coefficient a and the second coefficient b, in the sense of Bayes estimation, are represented as the Equation (12). In the Equation (12), D_{Ka} is the covariance matrix of the input disturbance weighted by the kernel matrix Kₐ with respect to the first coefficient a, as described in the first embodiment. D_{Kb} is the covariance matrix of the observed noise w weighted by the kernel matrix K_{b} with respect to the second coefficient b, and one of characterizing portions of the present embodiment. The calculation of D_{Ka} is same the same as the calculation of D_{K} in the first embodiment except using Kₐ instead of K. The calculation of D_{kb} is same as the calculation of D_{K} in the first embodiment except using K_{b} instead of K and using σ_{w} instead of σᵥ. To explain the novel portion of the present disclosure, the Non-Patent Literature 2 is referred. Although the Equation (36) and the Equation (37) of the Non-Patent Literature 2 correspond to the Equation (12) of the present embodiment, terms correspond to D_{Ka} and D_{Kb} are not recited in the equations of the Non-Patent Literature 2. Since D_{Ka} and D_{Kb} respectively represent impacts on the prior distribution of the prediction value of the output measurement value Y caused by the input disturbance and the observed noise represent, there is an error between the prior distribution in the technique which does not use D_{Ka} and D_{Kb} and the actual values. As a result, the conventional technique cannot accurately identify the prediction model.

In Equation (10) described above, N is the number of observation points (the number of steps) used for calculation, and n is the number of elements of a moving average or an autoregression. For example, the values of “N=100”, “n=10”, and the like are arbitrarily set. At this time, the identification unit 310 executes a process S11 of extracting an input measurement value vector u and an output measurement value vector y formed from measured values corresponding to N steps from the recording device 30 and acquiring these vectors represented in the following Equation (10). In addition, in Equations (11) and (12) described above, “σ_{w}” is a standard deviation of observed noise w and is assumed to have prior information of values thereof and approximate value thereof is known in advance. In the same way, “σᵥ” is a standard deviation of input disturbance v and is assumed to have prior information of values thereof and approximate value thereof is known in advance.

The values of “\hat{ }a” and “\hat{ }b” of Equation (12) described above are used for constants (a first coefficient a and a second coefficient b) of the prediction model.

The identification unit 310 updates the prediction model by executing the identification process S1 described above for every predetermined time (for example, 10 minutes). In this way, the identification unit 310 can constantly provide the prediction model according to changes in the characteristics of the prediction target 2. The predetermined time is arbitrarily set in accordance with a variation period and the like of the characteristics of the prediction target 2.

In addition, in the present embodiment, although an aspect in which both the lengths of the first coefficient a and the second coefficient b are the same values as n has been described as an example, the lengths thereof are not limited thereto. In another embodiment, the lengths of the first coefficient a and the second coefficient b may be different from each other.

In addition, the prediction unit 311 executes a prediction process S2 of predicting an output of the prediction target 2 at one step ahead (a time t+1) on the basis of constants (the first coefficient a and the second coefficient b) identified by the identification unit 310 and a prediction model formed from the input measurement value u and the output measurement value y.

A predicted value “\hat{ }yₜ₊₁” predicted by the prediction unit 311 is transmitted to the control device 210 of the prediction target 2. Then, the control device 210 performs control and adjustment on the basis of this predicted value “\hat{ }yₜ₊₁” such that the output of the prediction target 2 becomes an appropriate value.

### Application Example

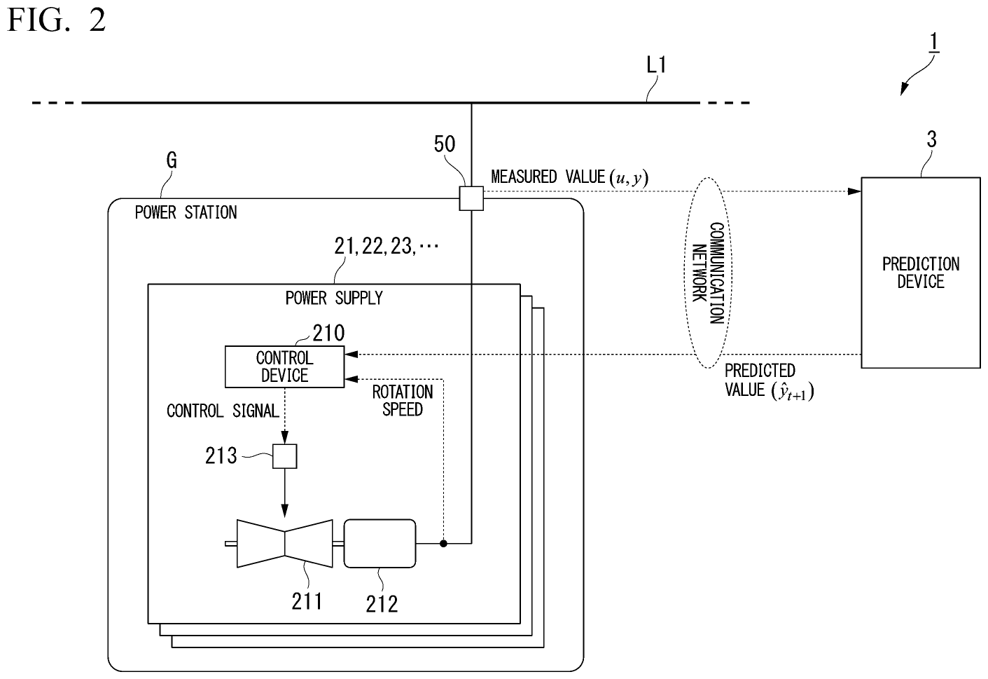

FIG. 2 is a diagram illustrating an application example of the prediction system according to the second embodiment of the present disclosure.

Hereinafter, one example of an application method of the prediction system 1 according to the present embodiment will be described with reference to FIG. 2. Further, the application example explained below can be applied to the first embodiment.

As illustrated in FIG. 2, the prediction system 1 according to the present embodiment is assumed to be an aspect in which output variations of electric power generated by a power station G are predicted for appropriately performing adjustment of supply and demand of electric power. Here, the adjustment of supply and demand of electric power represents that a frequency of an electric power system L1 is maintained as being constant. Users (a factory, a general household, and the like), who are not illustrated in the drawing, consuming electric power are connected to the electric power system L1, and each of such users consumes electric power as needed. As a general characteristic of the electric power system L1, the frequency of the electric power system L1 decreases when the consumption (demand) of electric power exceeds power generation (supply), and, on the other hand, the frequency increases when the supply exceeds the demand. A power station G adjusts the amount of generated power in accordance with the demand changing from time to time such that variations of the frequency do not deviate from a predetermined range (for example, a reference value±0.2 Hz). However, since there is a limit in the adjustment capability of the power station G, in a case in which adjustment of supply and demand is performed, it is effective to predict variations of the frequency in the future. The reason for this is that, in a case in which an increase or a decrease in the frequency is known in advance, the amount of generated power can be decreased or increased in advance.

On the basis of such knowledge, the prediction system 1 according to the present embodiment predicts frequency variations in the future in the power station G.

As illustrated in FIG. 2, the prediction system 1 includes a prediction device 3 and a measurement device 50. The prediction device 3 predicts the frequency (output) of electric power supplied from the power station G to the electric power system L1 in the future.

The measurement device 50 is installed at a connection point between the power station G and the electric power system L1 and can measure effective power at the connection point that is supplied from the power station G to the electric power system L1 and the frequency of the electric power system L1 at the connection point.

In addition, a plurality of power supplies 21, 22, 23, . . . that supply generated electric power to the electric power system L1 are disposed in the power station. It is assumed that all the power supplies 21, 22, 23, . . . have the same configuration. For this reason, here, the configuration of a power supply 21 among a plurality of power supplies will be described as an example. The power supply 21 includes a control device 210, a turbine device 211 (for example, a gas turbine, a steam turbine, or the like), a power generator 212, and a regulating valve 213.

The control device 210 is configured using a computer and performs control of operation of the turbine device 211 and the power generator 212. Particularly, the control device 210 constantly monitors the rotation speed (corresponding to the frequency of the output) of the power generator 212 and automatically adjusts the amount of supply of fuel or steam to the turbine device 211 such that the rotation speed is maintained as being constant. In addition, the control device 210 automatically adjusts the amount of supply of fuel or steam to the turbine device 211 on the basis of a predicted value “\hat{ }yₜ₊₁” of the frequency received from the prediction device 3.

The regulating valve 213 operates on the basis of a control signal received from the control device 210, thereby changing the amount of supply of fuel or steam supplied to the turbine device 211.

The power supply 21 is connected to the electric power system L1. The measurement device 50 is installed at the connection point between the power supply 21 and the electric power system L1. The measurement device 50 installed at the connection point between the power supply 21 and the electric power system L1 acquires a measured value of effective power output from the power supply 21 to the electric power system L1 and a measured value of the frequency of the power. The measurement device 50 transmits the measured values of the effective power and the frequency to the prediction device 3 through a predetermined communication network (an Internet line or the like). The prediction device 3 may be disposed inside the power station G. In addition, the prediction device 3 may be disposed inside the control device 210.

Similarly, a measurement device 50 installed at a connection point between any other power supply 22, 23, . . . and the electric power system L1 acquires a measured value of effective power output from the corresponding power supply 22, 23, . . . to the electric power system L1 and a measured value of the frequency of the power and transmits the acquired measured values to the prediction device 3. Here, the measured value of the effective power and the measured value of the frequency respectively correspond to the input measurement value u and the output measurement value y illustrated in FIG. 1.

In addition, details of the process of the control device 210 automatically adjusting the amount of supply of fuel or steam to the turbine device 211 on the basis of the predicted value “\hat{ }yₜ₊₁” of the frequency received from the prediction device 3 will be described. For example, the control device 210 uses the predicted value “\hat{ }yₜ₊₁” of the frequency for the degree of opening of the regulating valve 213. An output ΔP₁ that is additionally generated by the power station G in accordance with a deviation Δf of the frequency from a reference value can be represented in the following Equation (13) using a constant δ that is generally called an adjustment rate. Here, fₙ is a reference frequency of the electric power system L1, and Pₙ is rated outputs of the power supply 21, 22, 23, . . .

$$\begin{matrix}[ Math . 13 ] & \\ Δ {P}_{1} = \frac{1}{δ} {P}_{n} \frac{Δ f}{{f}_{n}} & ( 13 )\end{matrix}$$

Similarly, the control device 210 adjusts the degree of opening of the regulating valve 213 of fuel or steam in accordance with ΔP₂ calculated using the following Equation (14) on the basis of a deviation of the rotation speed from a reference value. Here, Rₙ is a rated number of rotation of the power generator 212.

$$\begin{matrix}[ Math . 14 ] & \\ Δ {P}_{2} = \frac{1}{δ} {P}_{n} \frac{Δ R}{{R}_{n}} & ( 14 )\end{matrix}$$

The control device 210 calculates a degree of opening instruction value of the regulating valve 213 on the basis of a weighted average of ΔP₁ and ΔP₂ acquired using each equation described above. The control device 210 transmit the degree of opening instruction value acquired in this way to the regulating valve 213 as a control signal, thereby adjusting the amount of supply of fuel or steam to the turbine device 211. In this way, the control device 210 can adjust effective power (inputs) of the power supplies 21, 22, 23, . . . with high accuracy such that the frequency (output) of the electric power system L1 can be appropriately maintained. In other words, the control device 210 can improve the adjustment capability of the power station G.

### (Operation and Effect)

As described above, the prediction device 3 of the prediction system 1 according to the present embodiment includes the processor 31 and the recording device 30 that is connected to the processor 31 and stores an input measurement value u that is a measured value of the input of the prediction target 2 and an output measurement value y that is a measured value of the output. The processor 31 executes the identification process S1 of identifying the first coefficient a for the input and the second coefficient b for the output using the autoregressive moving average filter from a plurality of input measurement values u and a plurality of output measurement values y stored in the past, and the prediction process S2 of predicting an output of the prediction target 2 in the future on the basis of a prediction model formed from the input measurement value u, the output measurement value y, the first coefficient a, and the second coefficient b. In the prediction method using a moving average filter, as described in the first embodiment, in a case in which the output measurement value y is changed by the impact of the external disturbance that cannot be observed, it cannot be taken into account because the technique of the first embodiment predicts the output only from the input measurement value u, and accordingly, there is a possibility of the prediction accuracy being decreased when the external disturbance is large. However, generally, since a prediction using the autoregressive moving average filter uses the output measurement value y in the past is used for the prediction, it is advantageous that the changes in the output measurement values is reflected to the prediction in a case in which the output measurement value y is changed by the impact of the eternal disturbance that cannot be observed. Further, the prediction by using the autoregressive moving average filter according to the present embodiment is characterized in that the covariance matrix of the input disturbance weighted by the kernel matrix with respect to the first coefficient and the covariance matrix of the observed noise weighted by the kernel matrix with respect to the second coefficient. With the features, the first coefficient a and the second coefficient b which associate the input measurement value u with the output measurement value y can be determined while the impacts of the input disturbance and the output disturbance that cannot be observed are taken into consideration. In this way, the prediction device 3 according to the second embodiment can inhibit a decrease in the prediction accuracy due to the external disturbance.

In addition, the prediction system 1 includes the prediction device 3 and the control device 210 that is communicatively connected to the prediction device 3 and adjusts an input of the prediction target 2 on the basis of a predicted value of the output of the prediction target 2 received from the prediction device 3.

In this way, the prediction system 1 can adjust the input with high accuracy such that the output of the prediction target 2 becomes an appropriate value.

For example, the prediction target 2 is the power supplies 21, 22, 23, . . . supplying electric power to the electric power system L1. The control device 210 adjusts the degrees of opening of the regulating valves 213 of the turbine devices 211 respectively included in the power supplies 21, 22, 23, . . . on the basis of the predicted value of the frequency (the output) of the electric power system L1.

In this way, the control device 210 of the prediction system 1 can adjust effective power (inputs) of the power supplies 21, 22, 23, . . . with high accuracy such that the frequency (the output) of the electric power system L1 can be appropriately maintained. In other words, the control device 210 can improve the adjustment capability of the power station G.

### Third Embodiment

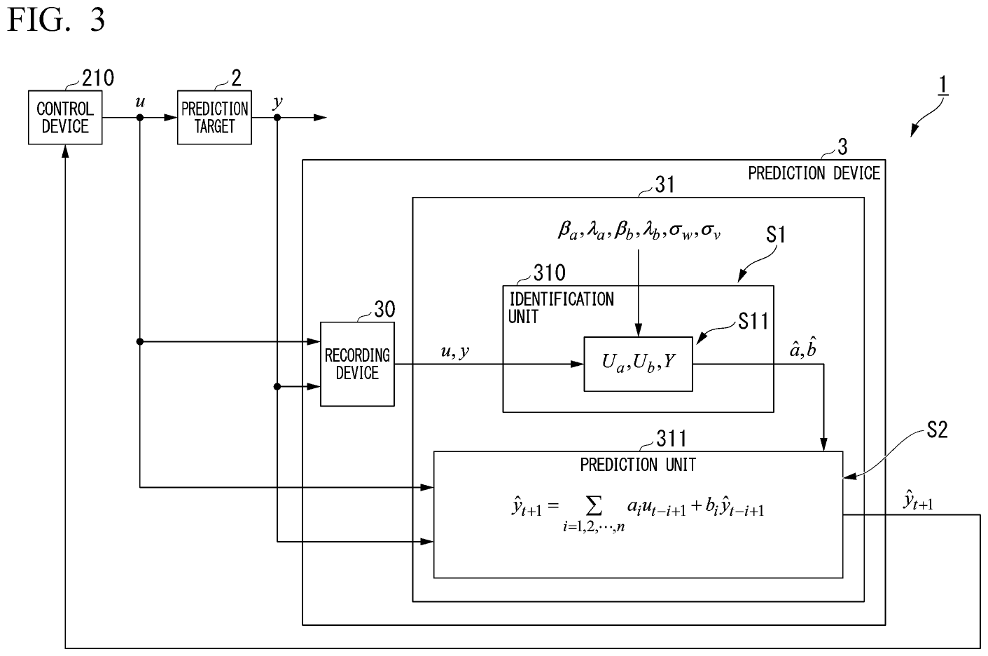

Next, a prediction device and a prediction system 1 including the prediction device according to a third embodiment of the present disclosure will be described with reference to FIG. 3. The difference between the second embodiment and the third embodiment is that the third embodiment uses an infinite impulse response filter (an IIR filter) while the second embodiment uses an autoregressive moving average filter (an ARMA filter). Since the difference affects only the identification process S1 performed by the identification unit 310 and the prediction process S2 performed by the prediction unit 311, these processes will be described below. The other functions and configurations are same as the first embodiment.

### (Process of Prediction Device by an Infinite Impulse Response Filter (an IIR Filter))

The identification unit 310 of the prediction device 3 according to the present embodiment performs the identification process S1 using an infinite impulse response filter instead of the moving average filter and the autoregressive moving average filter (the ARMA filter) of the first and second embodiments. In the infinite impulse response filter, an output “yₜ₊₁” of the prediction target 2 at one step ahead (a time t+1) is represented as in the following Equation (15A). “\hat{ }yₜ₊₁” is a prediction value of “yₜ₊₁”. The equation to obtain “\hat{ }yₜ₊₁” represents a prediction model of the present embodiment.

$$\begin{matrix}[ Math . 15 A ] & \\ \{ \begin{matrix}{x}_{t + 1} = {\sum }_{i = 1 , 2 , … , n} {a}_{i} ( {u}_{t - i + 1} + {v}_{t - i + 1} ) + {b}_{i} {x}_{t - i + 1} \\ {y}_{t + 1} = {x}_{t + 1} + {w}_{t + 1}\end{matrix} , \\ {\hat{y}}_{t + 1} = {\sum }_{i = 1 , 2 , … , n} {a}_{i} {u}_{t - i + 1} + {b}_{i} {\hat{y}}_{t - i + 1} & ( 15 A )\end{matrix}$$

The difference between the infinite impulse response filter and the autoregressive moving average filter is whether an internal state quantity x is present or not. In the autoregressive moving average filter, an output is predicted based on the input measurement value u and the output measurement value y. In the infinite impulse response filter, an internal state x is used instead of the output measurement value. In this way, the infinite impulse response filter can predict an output only from the input measurement value as well as the moving average filter, and thereby it can be easily implemented. Further, compared to the moving average filter, since the infinite impulse response filter needs the lower order (the smaller number of weighting factors n) than the moving average filter, it is advantageous to a numerical computing.

The kernel matrixes Kₐ and K_{b} are same as the second embodiment. A prior distribution of a constant [a^{T}, b^{T}]^{T} of a prediction model is represented a multivariate normal distribution shown in the Equation (15B).

$$\begin{matrix} [ Math . 15 B ] & \\ [ \begin{matrix}a \\ b \\ Y\end{matrix} ] \text{∼} 𝒩 ( [ \begin{matrix}0 \\ 0 \\ 0\end{matrix} ] , [ \begin{matrix}{K}_{a} & 0 & {K}_{a} {U}_{a}^{T} \\ 0 & {K}_{b} & {K}_{b} {U}_{b}^{T} \\ {U}_{a} {K}_{a} & {U}_{b} {K}_{b} & {U}_{a} {K}_{a} {U}_{a}^{T} + {U}_{b} {K}_{b} {U}_{b}^{T} + {D}_{{K}_{a}} + {σ}_{w}^{2} I\end{matrix} ] ) & ( 15 B )\end{matrix}$$

In the multivariate normal distribution of the Equation (15B), an element (3, 3) of the covariance matrix represents the covariance matrix Var(Y) of the prediction value of the output measurement value Y. In the Equation (15A), it is represented as: Var(Y)=UₐKₐUₐ^{T}+U_{b}J_{b}U_{b}^{T}+D_{Ka}+σ_{w}²I. This can be obtained as follows. When the time series of the observed noise {w₁, w₂, . . . w_{N}} is represented by a column vector W(N×1) and the time series of the input disturbance {v₁, v₂, . . . , v_{N}} is represented as a column vector V(N×1), it is represented as: Var(Y)=Var((Uₐ+V)a+U_{b}b+W)=E(Uₐaa^{T}Uₐ^{T})+E(U_{b}bb^{T}U_{b}^{T})+E(Vaa^{T}V^{T})+E((Uₐ+V)aW^{T})+E(Wa^{T}(Uₐ+V)^{T})+E(WW^{T}). Thus, it is represented as: Var(Y)=UₐKₐUₐ^{T}+U_{b}K_{b}U_{b}^{T}+D_{Ka}+0+0+σ_{w}²I. E(Vaa^{T}V^{T}) is a covariance matrix of the input disturbance weighted by the kernel matrix with respect to the first coefficient a and denoted by E(VKₐV^{T}) or D_{Ka}. In addition to the prior distribution, the output measurement value y is obtained, in the sense of the Bayes estimation, optimum estimates of the first coefficient a and the second coefficient b are represented as average values of a posterior distribution as shown in the Equation (15C).

$$\begin{matrix} [ Math . 15 C ] & \\ [ \begin{matrix}\hat{a} \\ \hat{b}\end{matrix} ] = [ \begin{matrix}{K}_{a} & 0 \\ 0 & {K}_{b}\end{matrix} ] ( [ \begin{matrix}{U}_{a}^{T} {U}_{a} {K}_{a} & {U}_{a}^{T} {U}_{b} {K}_{b} \\ {U}_{b}^{T} {U}_{a} {K}_{a} & {U}_{b}^{T} {U}_{b} {K}_{b}\end{matrix} ] + { [ \begin{matrix}{U}_{a}^{T} \\ {U}_{b}^{T}\end{matrix} ] {{D}_{{K}_{a}} [ {U}_{a} {U}_{b} ] [ \begin{matrix}{U}_{a}^{T} {U}_{a} & {U}_{a}^{T} {U}_{b} \\ {U}_{b}^{T} {U}_{a} & {U}_{b}^{T} {U}_{b}\end{matrix} ]}^{- 1} + {σ}_{w}^{2} {I}_{n} )}^{- 1} [ \begin{matrix}{U}_{a}^{T} \\ {U}_{b}^{T}\end{matrix} ] Y & ( 15 C )\end{matrix}$$

### (Operation and Effect)

As described above, the prediction device 3 of the prediction system 1 according to the present embodiment includes the processor 31 and the recording device 30 that is connected to the processor 31 and stores an input measurement value u that is a measured value of the input of the prediction target 2 and an output measurement value y that is a measured value of the output. The processor 31 executes the identification process S1 of identifying the first coefficient a for the input and the second coefficient b for the output using a model in the form of the infinite impulse response filter from a plurality of input measurement values u and a plurality of output measurement values y stored in the past, and the prediction process S2 of predicting an output of the prediction target 2 in the future on the basis of a prediction model formed from the input measurement value u, the output measurement value y, the first coefficient a, and the second coefficient b. By using the infinite impulse response filter, since it is able to predict an output only from the input measurement value y as well as the moving average filter, the implementation of the prediction device becomes easy. Further, compared to the moving average filter, there are advantages that, for example, it is advantageous to a numerical computing since the infinite impulse response filter needs the smaller number of the degree of filter (the number of weighting factors n) than the moving average filter.

### Fourth Embodiment

Next, a prediction system 1 according to a fourth embodiment of the present disclosure will be described with reference to FIG. 3.

The same reference signs will be assigned to constituent elements that are common to the first to third embodiments, and detailed description will be omitted.

A prediction device 3 according to the present embodiment predicts an output of a prediction target 2 at m steps ahead (a time t+m), which is different from the first embodiment.

### (Process of Prediction Device)

FIG. 3 is a diagram illustrating the functional configuration of a prediction system according to the fourth embodiment of the present disclosure.

As illustrated in FIG. 3, in the present embodiment, a predicted value “\hat{ }yₘ₊₁” of the output of the prediction target 2 at m steps ahead (a time t+m) is represented in the following Equation (16). An equation for acquiring this “\hat{ }yₜ₊₁” represents a prediction model according to the present embodiment.

$$\begin{matrix} [ Math . 16 ] & \\ {\hat{y}}_{t + m} = {\sum }_{i = 1 , 2 , … , m - 1} ( {b}_{i} {\hat{y}}_{t - i + m} + {a}_{i} {u}_{t - i + m} ) + {\sum }_{i = m , m + 1 , … , n} ( {b}_{i} {y}_{t - i + m} + {a}_{i} {u}_{t - i + m} ) & ( 16 )\end{matrix}$$

In Equation (16) presented above, a first term of the right side represents a prediction at m steps ahead. In addition, {uₜ₊₁, Uₜ₊₂, Uₜ₊ₘ₋₁} represents inputs in the future. {\hat{ }yₜ₊₁, \hat{ }yₜ₊₂, \hat{ }yₜ₊ₘ₋₁} represents predicted values of outputs in the future according to an infinite impulse response filter, an autoregressive moving average filter or a moving average filter. In the Equation (16), a second term of the right side represents an estimate of outputs in the past according to the autoregressive moving average filter. Further, {uₜ₋ₙ₊ₘ, uₜ₋ₙ₊ₘ₊₁, . . . uₜ} are input measurement values in the past, and {yₜ₋ₙ₊ₘ, yₜ₋ₙ₊ₘ₊₁, . . . yₜ} are output measurement values in the past.

A prediction unit 311 of the prediction device 3 predicts an output of the prediction target 2 at m steps ahead (a time t+m) on the basis of the prediction model represented by Equation (16) presented above in a prediction process S2. For example, an operator of the prediction system 1 may set the value of in to an arbitrary value in accordance with the prediction target 2.

The predicted value “\hat{ }yₜ₊ₘ” predicted by the prediction unit 311 is transmitted to the control device 210 of the prediction target 2. Then, the control device 210 performs control (adjustment) on the basis of this predicted value “\hat{ }yₜ₊ₘ” such that the output of the prediction target 2 becomes an appropriate value.

### (Operation and Effect)

As described above, the processor 31 (the prediction unit 311) of the prediction device 3 according to the present embodiment predicts an output of the prediction target after a predetermined time from the present (m steps ahead) in the prediction process S2.

In this way, the prediction device 3 can predict an output of the prediction target 2 a time ahead that is longer than that of the first embodiment.

In addition, the control device 210 of the prediction system 1 can adjust the output of the prediction target 2 from an early stage on the basis of the predicted value “\hat{ }yₜ₊ₘ” of the output at m steps ahead.

In addition, the application example according to the second embodiment can be also applied to the present embodiment. In such a case, the prediction system 1 can adjust effective power (inputs) of the power supplies 21, 22, 23, . . . such that the frequency (the output) of the electric power system L1 can be appropriately maintained from an early stage.

### Fifth Embodiment

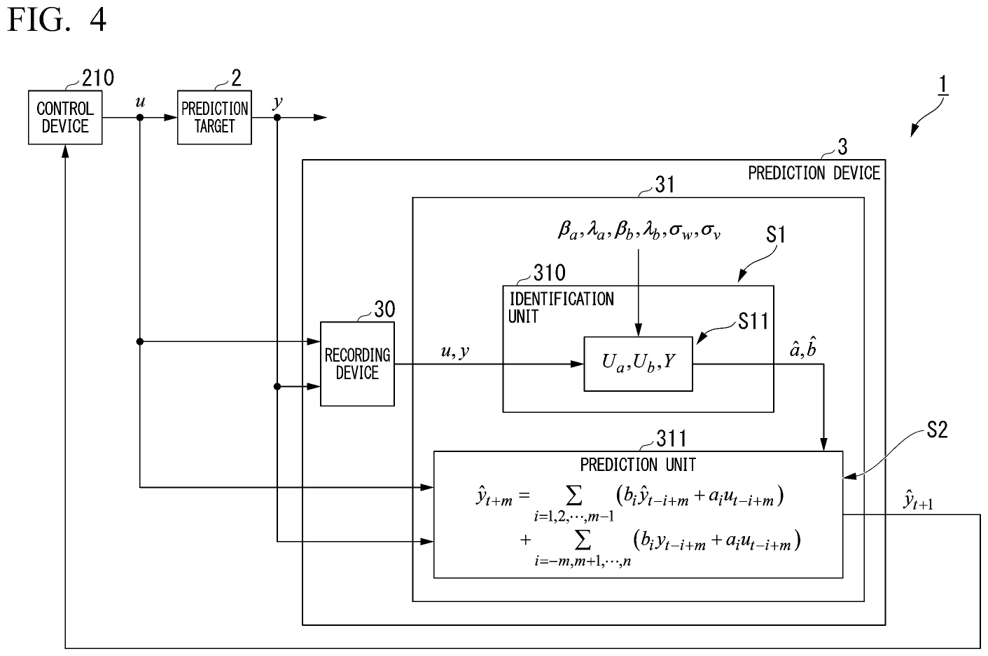

Next, a prediction system 1 according to a fifth embodiment of the present disclosure will be described with reference to FIG. 4.

The same reference signs will be assigned to constituent elements that are common to the first to fourth embodiments, and detailed description will be omitted.

A prediction device 3 according to the present embodiment handles a system having a plurality of types of inputs and a plurality of types of outputs or the like as a prediction target 2, which is different from the first and second embodiments.

FIG. 4 is a diagram illustrating the functional configuration of the prediction system according to the fifth embodiment of the present disclosure.

As illustrated in FIG. 4, a recording device 30 of a prediction device 3 according to the present embodiment stores input measurement values (an input vector) of a plurality of types and output measurement values (an output vector) of a plurality of types from the prediction target 2.

When the degree of an input is denoted by n^{u}, an input vector is denoted by [u¹, . . . , u^{nu}], a degree of an output is denoted by n_{y}, an output vector is denoted by [y¹, . . . , y^{ny}], an input disturbance is denoted by [v¹, . . . , v^{nu}], a standard deviation of the input disturbance is denoted by [σᵥ¹, . . . , σᵥ^{nu}], an observed noise is denoted by [y¹, . . . , y^{ny}] and a covariance matrix of the observed noise is denoted by [σ_{w}¹, . . . , σ_{w}^{ny}] an equation for predicting an output (a prediction model) is represented as in the following Equation (17) using coefficient vectors Aᵢ and Bᵢ (here, i=1, 2, . . . , n).

$$\begin{matrix} [ Math . 17 ] & \\ {[ {y}_{; 1} , … , {y}_{; {n}_{y}} ]}_{t + 1} = {\sum }_{i = 1 , 2 , … , n} ( ( {[ {y}_{; 1 , … ,} {y}_{; {n}_{y}} ]}_{t - i + 1} + {[ {w}_{; 1} , … , {w}_{; {n}_{y}} ]}_{t - i + 1} ) {B}_{i} + \\ ( {[ {u}_{; 1 , … ,} {u}_{; {n}_{u}} ]}_{t - i + 1} + {[ {v}_{; 1 , … ,} {v}_{; {n}_{u}} ]}_{t - i + 1} ) {A}_{i} ) + {[ {w}_{; 1} , … , {w}_{; {n}_{y}} ]}_{t + 1} & ( 17 )\end{matrix}$$

In addition, in the present embodiment, kernel matrixes K_{A} and K_{B} are defined as the following Equation (18) according to a first-degree stable spline kernel.

$$\begin{matrix}[ Math . 18 ] & \\ {K}_{A} = [ \begin{matrix}{k}_{A ; 1 , 1} & {k}_{A ; 1 , 2} & … & {k}_{A ; 1 , n} \\ {k}_{A ; 2 , 1} & {k}_{A ; 2 , 2} & & {k}_{A ; 2 , n} \\ ⋮ & & ⋱ & ⋮ \\ {k}_{A ; n , 1} & {k}_{A ; n , 2} & … & {k}_{A ; n , n}\end{matrix} ] , \\ {K}_{B} = [ \begin{matrix}{k}_{B ; 1 , 1} & {k}_{B ; 1 , 2} & … & {k}_{B ; 1 , n} \\ {k}_{B ; 2 , 1} & {k}_{B ; 2 , 2} & & {k}_{B ; 2 , n} \\ ⋮ & & ⋱ & ⋮ \\ {k}_{B ; n , 1} & {k}_{B ; n , 2} & … & {k}_{B ; n , n}\end{matrix} ] & ( 18 )\end{matrix}$$

Furthermore, elements in an i-th row and a j-th column of the kernel matrixes K_{A} and K_{B} are respectively given in the following Equations (19) and (20).

$$\begin{matrix}[ Math . 19 ] & \\ {k}_{A ; i , j} = [ \begin{matrix}{λ}_{A ; 1} {β}_{A ; 1}^{max \{ i , j \}} & 0 & 0 \\ 0 & ⋱ & 0 \\ 0 & 0 & {λ}_{A ; nu} {β}_{A ; nu}^{max \{ i , j \}}\end{matrix} ] , \\ {λ}_{A ; i} > 0 , 0 < {β}_{A ; i} < 1 , i , j ∈ \{ 1 , 2 , … {n}_{u} \} & ( 19 ) \\ [ Math . 20 ] & \\ {k}_{B ; i , j} = [ \begin{matrix}{λ}_{B ; 1} {β}_{A ; 1}^{max \{ i , j \}} & 0 & 0 \\ 0 & ⋱ & 0 \\ 0 & 0 & {λ}_{B ; ny} {β}_{B ; ny}^{max \{ i , j \}}\end{matrix} ] , \\ {λ}_{B ; i} > 0 , 0 < {β}_{B ; i} < 1 , i , j ∈ \{ 1 , 2 , … {n}_{y} \} & ( 20 )\end{matrix}$$

When a vector denotation represented in the following Equation (21) is introduced, a prior distributions of a constant [A^{T}, B^{T}]^{T} of the prediction model and the output Y are represented as the Equation (22). In addition to the prior distributions, when the output measurement value Y is obtained, an optimum estimate of the constant [A^{T}, B^{T}]^{T} of the prediction model is, in the sense of Bayes estimation, represented as the Equation (23). In the Equation (22), D_{KA} is the covariance matrix of the input disturbance weighted by the kernel matrix K_{A}, and D_{KB} is the covariance matrix of the input disturbance weighted by the kernel matrix K_{B}, each of which is one of characterizing portions of the present embodiment. The calculation of D_{KA} and D_{KB} is same as the first embodiment. In addition, denotations “\hat{ }A” and “\hat{ }B” in description here correspond to denotations in which a hat symbol “\hat{ }” is attached to “A” and “B” in the following drawings and equations described in the present embodiment.

$$\begin{matrix}[ Math . 21 ] & \\ {U}_{A} = [ \begin{matrix}{[ {u}_{; 1} , … , {u}_{; {n}_{u}} ]}_{0} & 0 & … & 0 \\ {[ {u}_{; 1} , … , {u}_{; {n}_{u}} ]}_{1} & {[ {u}_{; 1} , … , {u}_{; {n}_{u}} ]}_{0} & … & 0 \\ ⋮ & ⋮ & ⋱ & ⋮ \\ {[ {u}_{; 1} , … , {u}_{; {n}_{u}} ]}_{N - 2} & {[ {u}_{; 1} , … , {u}_{; {n}_{u}} ]}_{N - 3} & … & {[ {u}_{; 1} , … , {u}_{; {n}_{u}} ]}_{N - n - 1} \\ {[ {u}_{; 1} , … , {u}_{; {n}_{u}} ]}_{N - 1} & {[ {u}_{; 1} , … , {u}_{; {n}_{u}} ]}_{N - 2} & … & {[ {u}_{; 1} , … , {u}_{; {n}_{u}} ]}_{N - n}\end{matrix} ] , \\ {U}_{B} = [ \begin{matrix}{[ {y}_{; 1} , … , {y}_{; {n}_{y}} ]}_{0} & 0 & … & 0 \\ {[ {y}_{; 1} , … , {y}_{; {n}_{y}} ]}_{1} & {[ {y}_{; 1} , … , {y}_{; {n}_{y}} ]}_{0} & … & 0 \\ ⋮ & ⋮ & ⋱ & ⋮ \\ {[ {y}_{; 1} , … , {y}_{; {n}_{y}} ]}_{N - 2} & {[ {y}_{; 1} , … , {y}_{; {n}_{y}} ]}_{N - 3} & … & {[ {y}_{; 1} , … , {y}_{; {n}_{y}} ]}_{N - n - 1} \\ {[ {y}_{; 1} , … , {y}_{; {n}_{y}} ]}_{N - 1} & {[ {y}_{; 1} , … , {y}_{; {n}_{y}} ]}_{N - 2} & … & {[ {y}_{; 1} , … , {y}_{; {n}_{y}} ]}_{N - n}\end{matrix} ] , \\ Y = [ \begin{matrix}{[ {y}_{; 1} , … , {y}_{; {n}_{y}} ]}_{1} \\ {[ {y}_{; 1} , … , {y}_{; {n}_{y}} ]}_{2} \\ ⋮ \\ {[ {y}_{; 1} , … , {y}_{; {n}_{y}} ]}_{N - 1} \\ {[ {y}_{; 1} , … , {y}_{; {n}_{y}} ]}_{N}\end{matrix} ] & ( 21 ) \\ [ Math . 22 ] & \\ [ \begin{matrix}[ \begin{matrix}{A}_{1} \\ ⋮ \\ {A}_{{n}_{u}}\end{matrix} ] \\ [ \begin{matrix}{B}_{1} \\ ⋮ \\ {B}_{{n}_{y}}\end{matrix} ] \\ Y\end{matrix} ] \text{∼} 𝒩 ( [ \begin{matrix}{0}_{n \times {n}_{u}} \\ {0}_{n \times {n}_{y}} \\ {0}_{N \times {n}_{y}}\end{matrix} ] , \\ [ \begin{matrix}{K}_{A} & 0 & {K}_{A} {U}_{A}^{T} \\ 0 & {K}_{B} & {K}_{B} {U}_{B}^{T} \\ {U}_{A} {K}_{A} & {U}_{B} {K}_{B} & {U}_{A} {K}_{A} {U}_{A}^{T} + {U}_{B} {K}_{B} {U}_{B}^{T} + {D}_{{K}_{A}} + {D}_{{K}_{B}} + {\sum }_{1 = 1 , … , {n}_{y}} {σ}_{{w}_{i}}^{2} I\end{matrix} ] ) & ( 22 ) \\ [ Math . 23 ] & \\ [ \begin{matrix}[ \begin{matrix}{\hat{A}}_{1} \\ ⋮ \\ {\hat{A}}_{{n}_{u}}\end{matrix} ] \\ [ \begin{matrix}{\hat{B}}_{1} \\ ⋮ \\ {\hat{B}}_{{n}_{y}}\end{matrix} ]\end{matrix} ] = [ \begin{matrix}{K}_{A} & 0 \\ 0 & {K}_{B}\end{matrix} ] ( [ \begin{matrix}{U}_{A}^{T} {U}_{A} {K}_{A} & {U}_{A}^{T} {U}_{B} {K}_{B} \\ {U}_{B}^{T} {U}_{A} {K}_{A} & {U}_{B}^{T} {U}_{B} {K}_{B}\end{matrix} ] + [ \begin{matrix}{U}_{A}^{T} \\ {U}_{B}^{T}\end{matrix} ] {( {D}_{{K}_{A}} + {D}_{{K}_{B}} ) [ \begin{matrix}{U}_{A} & {U}_{B}\end{matrix} ] [ \begin{matrix}{U}_{A}^{T} {U}_{A} & {U}_{A}^{T} {U}_{B} \\ {U}_{B}^{T} {U}_{A} & {U}_{B}^{T} {U}_{B}\end{matrix} ]}^{- 1} + {{\sum }_{1 = 1 , … , {n}_{y}} {σ}_{{w}_{i}}^{2} {I}_{n} )}^{- 1} [ \begin{matrix}{U}_{A}^{T} \\ {U}_{B}^{T}\end{matrix} ] Y & ( 23 )\end{matrix}$$

In Equation (23) presented above, “\hat{ }A” is a matrix of which a size is n×nᵤ, and “\hat{ }B” is a matrix of which a size is n×n_{y}. The values of these “\hat{ }A” and “\hat{ }B” are used for constants (the first coefficient A and the second coefficient B) of the prediction model. Aᵢ and Bᵢ (here, i=1, 2, . . . , n) of the prediction model are respectively the i-th row vectors of A and B.

The identification unit 310 updates the prediction model by executing the identification process S1 described above for every predetermined time. In this way, the identification unit 310 can constantly provide the prediction model according to changes in the characteristics of the prediction target 2. The predetermined time is arbitrarily set in accordance with a variation period and the like of the characteristics of the prediction target 2.

In addition, in the present embodiment, although an example in which both the numbers of the rows of the first coefficient A and the second coefficient B are the same values as n is illustrated, the numbers of the rows are not limited thereto. In another embodiment, the number of rows of the first coefficient A and the second coefficient B may be different from each other.

In addition, the prediction unit 311 executes a prediction process S2 of predicting values of a plurality of types (n_{y} types) of outputs of the prediction target 2 at one step ahead (a time t+1) on the basis of constants (the first coefficient A and the second coefficient B) identified by the identification unit 310 and a prediction model formed from the input measurement values u (the input vector) and the output measurement values y (the output vector).

Predicted values [\hat{ }y_{;1}, . . . , \hat{ }y_{;ny}]ₜ₊₁ predicted by the prediction unit 311 are transmitted to the control device 210 of the prediction target 2. Then, the control device 210 performs control and adjustment on the basis of this predicted values [\hat{ }y_{;1}, . . . , \hat{ }y_{;ny}]ₜ₊₁ such that each output value of the prediction target 2 becomes an appropriate value.

In addition, although an aspect in which the prediction unit 311 predicts outputs at one step ahead (the time t+1) has been described as an example in the present embodiment, the outputs are not limited thereto. Similar to the second embodiment, the prediction unit 311 may be configured to predict outputs at m steps ahead (a time t+m).

### (Operation and Effect)

As described above, the recording device 30 of the prediction device 3 according to the present embodiment stores input measurement values u of a plurality of types and output measurement values y of a plurality of types of the prediction target 2, and the processor 31 (the identification unit 310) identifies a plurality of first coefficients A for the plurality of types of inputs and a plurality of second coefficients B for the plurality of types of outputs in the identification process S1.

In this way, even in a case in which the prediction target 2 is a system or the like having a plurality of types of inputs and a plurality of types of outputs, the prediction device 3 can predict the plurality of types of outputs of the prediction target 2.

In addition, the application example according to the second embodiment can be also applied to the present embodiment. In such a case, the prediction device 3 may use any other measurement value (for example, the amount of generated power of the power generator 212 or the like) in addition to a measured value of effective power received from the measurement device 50 as an input measurement value. In addition, a measured value of effective power received from another power station, solar radiation, wind power, and the like controlling power generation using natural energy such as solar light and wind power may be used. Similarly, the prediction device 3 may use another measured value (for example, a rotation speed of the power generator 212 or the like) in addition to a measured value of the frequency received from the measurement device 50 as an output measurement value. In addition, a frequency or a rotation speed of a power generator received from another power station may be used.

### <Hardware Configuration>

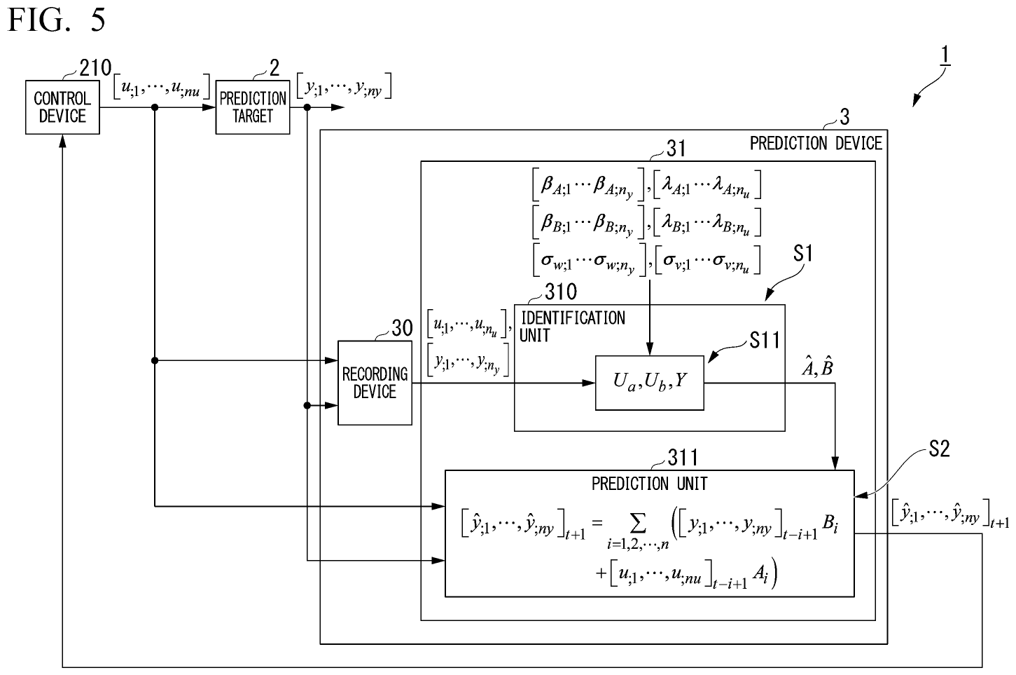

FIG. 5 is a diagram illustrating one example of the hardware configurations of a prediction device and a control device according to at least one embodiment of the present disclosure.

As illustrated in FIG. 5, a computer 900 includes a processor 901, a main memory 902, a storage 903, and an interface 904.

The prediction device 3 and the control device 210 described above are mounted in the computer 900. The operation of each processing unit described above is stored in the storage 903 in the form of a program. The processor 901 reads the program from the storage 903, loads the program in the main memory 902, and executes the process described above in accordance with the program. In addition, the processor 901 secures a storage area corresponding to each storage unit described above in the main memory 902 in accordance with the program.

The program may be used for realizing some of the functions of the computer 900. For example, the program may realize functions by being combined with another program stored in the storage 903 in advance or being combined with another program mounted in another device. In another embodiment, the computer 900 may include a custom large scale integrated circuit (LSI) such as a programmable logic device (PLD) in addition to the configuration described above or instead of the configuration described above. Examples of the PLD include a programmable array logic (PAL), a generic array logic (GAL), a complex programmable logic device (CPLD), or a field programmable gate array (FPGA). In such a case, some or all of the functions realized by the processor 901 may be realized by the integrated circuit.

As examples of the storage 903, there are a magnetic disk, a magneto-optical disk, an optical disc, a semiconductor memory, and the like. The storage 903 may be an internal medium that is directly connected to a bus of the computer 900 or an external medium 910 that is connected to the computer 900 through the interface 904 or a communication line. In addition, in a case in which this program is distributed to the computer 900 using a communication line, the computer 900 that has received the distribution may load the program into the main memory 902 and execute the process described above. At least one embodiment, the storage 903 is a non-transitory tangible storage medium.

In addition, the program may be used for realizing some of the functions described above. Furthermore, the program may be a so-called differential file (a differential program) realizing the functions described above by being combined with another program that has been stored in the storage 903 in advance.

According to a second aspect of the present disclosure, a prediction device that is configured to predict an output of a prediction target in the future, the prediction device comprising: a processor; and a recording device that is connected to the processor and is configured to store an input measurement value that is a measured value of an input of the prediction target and an output measurement value that is a measured value of the output. The processor is configured to execute: an identification process of identifying a first coefficient for the input and a second coefficient for the output using an autoregressive moving average filter from a plurality of input measurement values and a plurality of output measurement values stored in the past; and a prediction process of predicting the output of the prediction target in the future on the basis of a prediction model formed from the input measurement values, the output measurement values, the first coefficient, and the second coefficient. In the identification process, a covariance matrix of input disturbance weighted by a kernel matrix with respect to the first coefficient and a covariance matrix of observed noise weighted by a kernel matrix with respect to the second coefficient are used.

According to a third aspect of the present disclosure, a prediction device that is configured to predict an output of a prediction target in the future, the prediction device comprising: a processor; and a recording device that is connected to the processor and is configured to store an input measurement value that is a measured value of an input of the prediction target and an output measurement value that is a measured value of the output. The processor is configured to execute: an identification process of identifying a first coefficient for the input and a second coefficient for the output using an infinite impulse response filter from a plurality of input measurement values and a plurality of output measurement values stored in the past; and a prediction process of predicting the output of the prediction target in the future on the basis of a prediction model that is in a form of an infinite impulse response filter formed from the input measurement values, the output measurement values, the first coefficient, and the second coefficient. In the identification process, a covariance matrix of input disturbance weighted by a kernel matrix with respect to the first coefficient is used.

According to a fourth aspect of the present disclosure, the processor is configured to predict the output of the prediction target after a predetermined time from the present in the prediction process.

According to a fifth aspect of the present disclosure, the recording device is configured to store input measurement values of a plurality of types and output measurement values of a plurality of types of the prediction target. The processor is configured to identify a plurality of first coefficients for the plurality of types of inputs and a plurality of second coefficients for the plurality of types of outputs in the identification process.

According to a sixth aspect of the present disclosure, there is provided a prediction system including: the prediction device described in any one of the first to third aspects; and a control device that is communicatively connected to the prediction device and is configured to adjust the input of the prediction target on the basis of the predicted value of the output of the prediction target received from the prediction device.

According to a seventh aspect of the present disclosure, the prediction target is a power supply that is configured to supply electric power to an electric power system, and the control device is configured to adjust a degree of opening of a regulating valve of a turbine device included in the power supply on the basis of the predicted value.

According to an eighth aspect of the present disclosure, there is provided a prediction method for predicting an output of a prediction target in the future including: identifying a first coefficient for an input using a moving average filter from input measurement values that are measured values of a plurality of the inputs in the past and output measurement values that are measured values of a plurality of the outputs in the past; and predicting the output of the prediction target in the future on the basis of a prediction model formed from the input measurement values, the output measurement values, and the first coefficient. In the step of identifying the first coefficient a covariance matrix of input disturbance weighted by a kernel matrix with respect to the first coefficient is used.[0136]

According to a ninth aspect of the present disclosure, there is provided a non-transitory computer-readable medium that stores a program causing a computer of a prediction device including a processor and a recording device that is connected to the processor and is configured to store an input measurement value that is a measured value of an input of a prediction target and an output measurement value that is a measured value of an output to function, the program causing the computer to execute: identifying a first coefficient for an input using a moving average filter from input measurement values that are measured values of a plurality of the inputs in the past and output measurement values that are measured values of a plurality of the outputs in the past; and predicting the output of the prediction target in the future on the basis of a prediction model formed from the input measurement values, the output measurement values, and the first coefficient. In the step of identifying the first coefficient, a covariance matrix of input disturbance weighted by a kernel matrix with respect to the first coefficient is used.

While preferred embodiments of the invention have been described and illustrated above, it should be understood that these are exemplary of the invention and are not to be considered as limiting. Additions, omissions, substitutions, and other modifications can be made without departing from the spirit or scope of the present disclosure. Accordingly, the invention is not to be considered as being limited by the foregoing description, and is only limited by the scope of the appended claims.

### REFERENCE SIGNS LIST

1 Prediction system
2 Prediction target
21, 22, 23 Power supply
210 Control device
211 Turbine device
212 Power generator
213 Regulating valve
3 Prediction device
30 Recording device
31 Processor
310 Identification unit
311 Prediction unit
50 Measurement device

1. A prediction device that is configured to predict an output of a prediction target in the future, the prediction device comprising:
a processor; and
a recording device that is connected to the processor and is configured to store an input measurement value that is a measured value of an input of the prediction target and an output measurement value that is a measured value of the output,
wherein the processor is configured to execute:
an identification process of identifying a first coefficient for the input using a moving average filter from a plurality of input measurement values and a plurality of output measurement values stored in the past; and
a prediction process of predicting the output of the prediction target in the future on the basis of a prediction model formed from the input measurement values, the output measurement values, and the first coefficient, and
wherein in the identification process, a covariance matrix of input disturbance weighted by a kernel matrix with respect to the first coefficient is used.

2. A prediction device that is configured to predict an output of a prediction target in the future, the prediction device comprising:
a processor; and
a recording device that is connected to the processor and is configured to store an input measurement value that is a measured value of an input of the prediction target and an output measurement value that is a measured value of the output,
wherein the processor is configured to execute:
an identification process of identifying a first coefficient for the input and a second coefficient for the output using an autoregressive moving average filter from a plurality of input measurement values and a plurality of output measurement values stored in the past; and
a prediction process of predicting the output of the prediction target in the future on the basis of a prediction model formed from the input measurement values, the output measurement values, the first coefficient, and the second coefficient, and
wherein in the identification process, a covariance matrix of input disturbance weighted by a kernel matrix with respect to the first coefficient and a covariance matrix of observed noise weighted by a kernel matrix with respect to the second coefficient are used.

3. A prediction device that is configured to predict an output of a prediction target in the future, the prediction device comprising:
a processor; and
a recording device that is connected to the processor and is configured to store an input measurement value that is a measured value of an input of the prediction target and an output measurement value that is a measured value of the output,
wherein the processor is configured to execute:
an identification process of identifying a first coefficient for the input and a second coefficient for the output using an infinite impulse response filter from a plurality of input measurement values and a plurality of output measurement values stored in the past; and
a prediction process of predicting the output of the prediction target in the future on the basis of a prediction model that is in a form of an infinite impulse response filter formed from the input measurement values, the output measurement values, the first coefficient, and the second coefficient, and
wherein in the identification process, a covariance matrix of input disturbance weighted by a kernel matrix with respect to the first coefficient is used.

4. The prediction device according to claim 1, wherein the processor is configured to predict the output of the prediction target after a predetermined time from the present in the prediction process.

5. The prediction device according to claim 2,
wherein the recording device is configured to store input measurement values of a plurality of types and output measurement values of a plurality of types of the prediction target, and
wherein the processor is configured to identify a plurality of first coefficients for the plurality of types of inputs and a plurality of second coefficients for the plurality of types of outputs in the identification process.

6. A prediction system comprising:
the prediction device according to claim 1; and
a control device that is communicatively connected to the prediction device and is configured to adjust the input of the prediction target on the basis of the predicted value of the output of the prediction target received from the prediction device.

7. The prediction system according to claim 6,
wherein the prediction target is a power supply that is configured to supply electric power to an electric power system, and
wherein the control device is configured to adjust a degree of opening of a regulating valve of a turbine device included in the power supply on the basis of the predicted value.

8. A prediction method for predicting an output of a prediction target in the future, the prediction method comprising: identifying a first coefficient for an input using a moving average filter from input measurement values that are measured values of a plurality of the inputs in the past and output measurement values that are measured values of a plurality of the outputs in the past; and
predicting the output of the prediction target in the future on the basis of a prediction model formed from the input measurement values, the output measurement values, and the first coefficient,
wherein in the step of identifying the first coefficient, a covariance matrix of input disturbance weighted by a kernel matrix with respect to the first coefficient is used.

9. A non-transitory computer-readable medium that stores a program causing a computer of a prediction device including a processor and a recording device that is connected to the processor and is configured to store an input measurement value that is a measured value of an input of a prediction target and an output measurement value that is a measured value of an output to function, the program causing the computer to execute:
identifying a first coefficient for an input using a moving average filter from input measurement values that are measured values of a plurality of the inputs in the past and output measurement values that are measured values of a plurality of the outputs in the past; and
predicting the output of the prediction target in the future on the basis of a prediction model formed from the input measurement values, the output measurement values, and the first coefficient,
wherein in the step of identifying the first coefficient, a covariance matrix of input disturbance weighted by a kernel matrix with respect to the first coefficient is used.
